(19) United States
(12) Patent Application Publication
(10) Pub. No.: US 2014/0362036 A1
(43) Pub. Date: Dec. 11, 2014

(54) CAPACITIVE TOUCH SCREEN

(71) Applicant: FocalTech Systems, Ltd., Grand Cayman (KY)

(72) Inventors: Lianghua Mo, Shenzhen (CN); Guang Ouyang, Shenzhen (CN)

(73) Assignee: FocalTech Systems, Ltd., Grand Cayman (KY)

(21) Appl. No.: 14/099,277

(22) Filed: Dec. 6, 2013

(30) Foreign Application Priority Data
Jun. 6, 2013 (CN) 201310224577.6

(51) Int. Cl. G06F 3/044

(52) U.S. Cl. CPC G06F 3/044
USPC 345/174

(57) ABSTRACT

A capacitive touch screen is provided, which includes: a transparent cover lens; multiple sensing electrodes disposed on a surface of the transparent cover lens and arranged into a two-dimensional array; and a touch control chip bonded onto the surface of the transparent cover lens, the touch control chip being connected with each of the multiple sensing electrodes via a wire. The capacitive touch screen may decrease errors caused by the transmission of noises between electrodes in the prior art on the premise of implementing multi-ouch, thus significantly improving signal-to-noise ratio (SNR).

The present application claims the priority to Chinese Patent Application No. 201310224577.6, filed with the Chinese Patent Office on Jun. 6, 2013, entitled as “CAPACITIVE TOUCH SCREEN”, the entire content of which is incorporated herein by reference.

### FIELD OF THE PRESENT INVENTION

The present disclosure relates to the field of touch control technology, and particularly to a capacitive touch screen.

### BACKGROUND OF THE PRESENT INVENTION

Presently, a capacitive touch screen is widely used in various electronic products, and has gradually applied to various fields of people's working and life. The size of the capacitive touch screen has increasingly become bigger, ranging from 3-6.1 inch for a smart phone to about 10 inch for a tablet. Further, the application field of the capacitive touch screen may further be extended to a smart TV and so on. However, the existing capacitive touch screen commonly has problems of poor anti-interference ability, low frame rate, large size and complicated manufacture process and so on.

### SUMMARY OF THE PRESENT INVENTION

In view of this, a capacitive touch screen is provided according to the embodiments of the present disclosure to solve at least one of the above problems.

A capacitive touch screen according to the embodiments of the present disclosure includes:

a transparent cover lens;

a plurality of sensing electrodes disposed on a surface of the transparent cover lens and arranged into a two-dimensional array; and

a touch control chip bonded onto the surface of the transparent cover lens, the touch control chip being connected with each of the plurality of sensing electrodes via a wire.

Preferably, the capacitive touch screen further includes a flexible printed circuit connected with the touch control chip, the touch control chip and the flexible printed circuit being bonded onto the surface of the transparent cover lens via an anisotropic conductive film (ACF).

Preferably, the transparent cover lens is provided with a view area.

Preferably, the capacitive touch screen further includes a light shielding layer disposed outside the view area of the transparent cover lens.

Preferably, the plurality of sensing electrodes are disposed on a lower surface of the transparent cover lens, the touch control chip and the flexible printed circuit are disposed on the lower surface of the transparent cover lens outside the view area, and a light shielding layer is disposed on the lower surface of the transparent cover lens and located above the touch control chip and the flexible printed circuit.

Preferably, the capacitive touch screen further includes a transparent film covering an upper surface of the transparent cover lens.

Preferably, the plurality of sensing electrodes are disposed on the lower surface of the transparent cover lens, the touch control chip and the flexible printed circuit are disposed on the lower surface of the transparent cover lens outside the view area, and the light shielding layer is disposed on a lower surface of the transparent film.

Preferably, the light shielding layer is made of ink in various colors, or a light shielding material capable of being combined with the transparent cover lens or the transparent film.

Preferably, the transparent film is a polyethylene terephthalate (PET) film, a polycarbonate (PC) film or a polymethylmethacrylate (PMMA) film.

Preferably, the transparent film is adhered to the transparent cover lens via a whole piece of optical clear adhesive, or the transparent film is adhered to the transparent cover lens via double sided adhesive.

Preferably, the touch control chip is adapted to detect a self-capacitance of each of the sensing electrodes.

Preferably, the touch control chip is adapted to detect the self-capacitance of each of the sensing electrodes by:

driving the sensing electrodes with a voltage source or a current source; and

detecting a voltage, a frequency or an electrical quantity on each of the sensing electrodes.

Preferably, the touch control chip is adapted to detect the self-capacitance of each of the sensing electrode by:

driving and detecting the sensing electrodes, and driving the rest of the sensing electrodes simultaneously, wherein a signal for driving the sensing electrodes and a signal for driving the rest of the sensing electrodes are a same voltage or current signal, or different voltage or current signal; or

driving and detecting one of the sensing electrodes, and driving sensing electrodes periphery to the driven sensing electrode simultaneously, wherein a signal for driving the sensing electrodes and a signal for driving sensing electrodes periphery to the driven sensing electrode are a same voltage or current signal, or different voltage or current signals.

Preferably, the touch control chip is adapted to detect the self-capacitance of each of the sensing electrode by:

detecting all of the sensing electrodes simultaneously; or

detecting the sensing electrodes group by group.

Preferably, the touch control chip is adapted to determine a touch position according to a two-dimensional sensing array.

Preferably, the capacitive touch screen includes a plurality of touch control chips bonded onto the transparent cover lens, where each touch control chip is adapted to detect a corresponding part of the plurality of sensing electrodes.

In the capacitive touch screen according to the embodiments of the present disclosure, under the premise of achieving multi-touch, a plurality of sensing electrodes being arranged in a two-dimensional array are applied to decreasing errors caused by noises accumulation between electrodes in the prior art, thus significantly improving signal-to-noise ratio (SNR). With the scheme of the embodiments of the present disclosure, power supply noises in a touch screen are greatly eliminated, and interferences from radio frequency (RF) and from other noise sources such as a liquid crystal display module can also be weakened.

According to the capacitive touch screen according to the embodiments of the present disclosure, the touch control chip is connected with each sensing electrode via a wire, and bonded to the transparent cover lens in chip-on-glass (COG) mode. Therefore, it is able to avoid packaging difficulty caused by a large number of pins, and also reduce the overall size. Furthermore, scanning time can be significantly reduced by detecting the sensing electrodes simultaneously or in groups, thus avoiding a problem caused by a large number of sensing electrodes.

### BRIEF DESCRIPTION OF THE DRAWINGS

FIG. 1 is a top view of a capacitive touch screen according to a first embodiment of the present disclosure;

FIG. 2 is a top view of a sensing electrode array according to the first embodiment of the present disclosure;

FIG. 3 is a schematic diagram of a layer structure of a capacitive touch screen according to a second embodiment of the present disclosure;

FIG. 4 is a schematic diagram of a layer structure of a capacitive touch screen according to a third embodiment of the present disclosure;

FIG. 5 to FIG. 8 show methods for driving sensing electrodes according to the embodiments of the present disclosure;

FIG. 9 shows four application situations for a capacitive touch screen according to the embodiments of the present disclosure;

FIG. 10 shows a signal-flow diagram of a touch control chip according to the embodiments of the present disclosure;

FIG. 11A shows an example for calculating coordinates of a touch position in a centroid algorithm; and

FIG. 11B shows an example for calculating coordinates of a touch position in a centroid algorithm in a case where a noise exists.

### DETAILED DESCRIPTION OF THE PRESENT INVENTION

To make the objectives, features and advantages of the present disclosure more obvious and easy to be understood, in the following, the technical solution of the embodiments of the present disclosure will be described in conjunction with the accompanying drawings in the embodiments of the present disclosure. Obviously, the described embodiments are only a part of embodiments of the present disclosure. Based on the embodiments of the present disclosure, any other embodiments obtained by those skilled in the art without any creative work should fall within the scope of protection of the present disclosure. For ease of illustration, sectional diagrams showing the structure are enlarged partially on the usual scale, and the drawings are only examples, which should not be understood as limiting the scope of protection of the present disclosure. Furthermore, in an actual manufacture process, three-dimensioned sizes, i.e. length, width and depth should be considered.

### First Embodiment

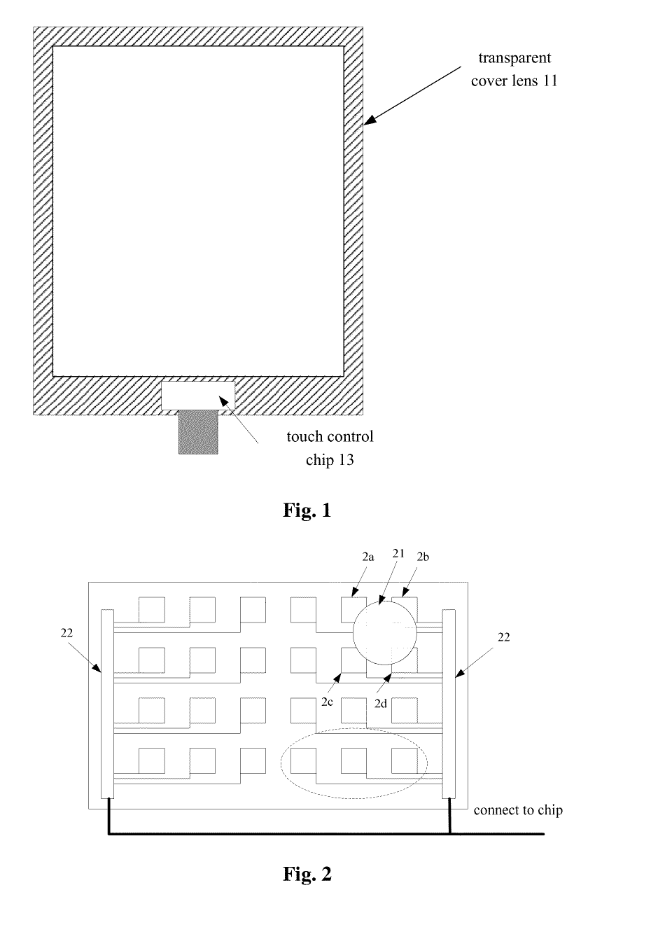

A capacitive touch screen is provided according to the first embodiment of the present disclosure. FIG. 1 is a top view of the capacitive touch screen. The capacitive touch screen includes: a transparent cover lens 11; multiple sensing electrodes 12 (not shown in FIG. 1) disposed on a surface of the transparent cover lens and arranged into a two-dimensional array; and a touch control chip 13 bonded to the surface of the transparent cover lens, the touch control chip 13 being connected with each of the multiple sensing electrodes 12 via a wire.

The transparent cover lens 11 may be made of transparent glass. The multiple sensing electrodes 12 are disposed on the transparent cover lens 11. The multiple sensing electrodes 12 are arranged into a two-dimensional array, which may be a rectangular array or a two-dimensional array in other similar shapes. For the capacitive touch screen, each sensing electrode 12 is a capacitive sensor, and capacitance of the capacitive sensor will be changed when a corresponding position on the touch screen is touched.

Each sensing electrode 12 is connected to the touch control chip 13 via a wire, and the touch control chip 13 is bonded to the transparent cover lens. The touch control chip 13 has a large number of pins since the touch control chip 13 is connected with each sensing electrode 12 via a wire. Therefore, a difficulty in conventional packaging can be avoided by bonding the touch control chip 13 to the transparent cover lens. In particular, the touch control chip 13 may be bonded to the transparent cover lens 11 in a chip-on-glass (COG) mode. According to the embodiment of the present disclosure, an anisotropic conductive film (ACF) may be provided between the touch control chip 13 and the transparent cover lens 11.

Furthermore, in a case where the sensing electrodes are connected to the control touch chip by a conventional flexible printed circuit (FPC), some spaces need to be reserved for the touch control chip and the FPC for hardware requirement, which is not favorable to simplify the system. However, the touch control chip and the touch screen are integrated together in the COG mode, thus reducing the size of the whole touch screen.

Since the sensing electrodes 12 are generally formed by etching indium tin oxide (ITO) on the transparent cover lens and the touch control chip 13 is also located on the transparent cover lens, the wires between the sensing electrodes 12 and the touch control chip 13 may be implemented in one-step ITO etching, thus significantly simplifying the manufacture process.

FIG. 2 is a top view of the sensing electrode array according to the embodiment of the present disclosure. It should be understood by those skilled in the art that, only one arrangement for the sensing electrodes is shown in FIG. 2, and the sensing electrodes may be arranged into any two-dimensional array in a specific embodiment. For the capacitive touch screen, each sensing electrode 12 is a capacitive sensor, and the capacitance of the capacitive sensor may be changed when a certain position on the touch screen is touched.

Furthermore, the spacing between the sensing electrodes in any direction may be equal, or may also be unequal. It also should be understood by those skilled in the art that the number of the sensing electrodes may be larger than the number shown in FIG. 2.

It should be understood by those skilled in the art that FIG. 2 only shows one shape of the sensing electrode. According to other embodiments, the sensing electrode may be in a shape of a rectangle, a diamond, a circle or an oval, and may also be in an irregular shape. The patterns of sensing electrodes may be uniform or non-uniform. For example, a diamond structure is used for the sensing electrodes in the center, while a triangle structure is used for the sensing electrodes at the edge. Furthermore, the sizes of sensing electrodes may be uniform or non-uniform. For example, the sensing electrodes close to the center have a larger size, while the sensing electrodes close to the edge have a smaller size, which facilitates the routing and improves the touch accuracy at the edge.

Each sensing electrode is led out via a wire disposed in the gap between the sensing electrodes. Generally, the wire is as uniform as possible, and the routing is as short as possible. Furthermore, the routing range of the wire should be as narrow as possible on the premise of a safe distance, thus leaving more area for the sensing electrodes and implementing the accurate sensing.

Each sensing electrode may be connected to a bus 22 via a wire, and the bus 22 connects the wires to pins of the touch control chip directly or after proper ordering. There can be numerous sensing electrodes in a large size touch screen. In this case, a single touch control chip may be configured to control all of the sensing electrodes. Alternatively, by partitioning the screen, multiple touch control chips may also be configured to separately control sensing electrodes in different regions, where clock synchronization may be performed between the multiple touch control chips. In this case, the bus 22 may be divided into several bus groups to be connected with different touch control chips respectively. Each touch control chip controls the same number of the sensing electrodes or different number of the sensing electrodes.

The sensing electrode array shown in FIG. 2 is based on a self-capacitance touch detection principle. Each sensing electrode corresponds to a specific position on the screen. In FIGS. 2, 2a to 2d represent sensing electrodes, and 21 represents a touch. When the touch takes place on a position corresponding to a sensing electrode, the electric charges on the sensing electrode change. Therefore, the occurrence of a touch event on the sensing electrode may be determined by detecting the electric charges (current or voltage) on the sensing electrode. Generally, this can be achieved by converting an analog signal into a digital signal with an Analog-Digital Converter (ADC). The change in electric charges on the sensing electrode relates to the area of the sensing electrode covered by the touch. For example, in FIG. 2, the changes in electric charges on the sensing electrodes 2b and 2d are larger than the changes in electric charges on the sensing electrodes 2a and 2c.

Each position on the screen corresponds to a sensing electrode, and there is no physical connection between the sensing electrodes. Therefore, the capacitive touch screen provided by the embodiment of the present disclosure can realized real multi-touch, and avoid ghost points in the self-capacitance touch detection in the prior art.

### Second Embodiment

FIG. 3 is a lateral structure schematic diagram of a capacitive touch screen according to a second embodiment of the present disclosure. Compared with the first embodiment, the capacitive touch screen disclosed in this embodiment further includes a light shielding layer 14, and a view area provided on the transparent cover lens 11. The light shielding layer is disposed outside the view area of the transparent cover lens 11. As shown in FIG. 3, multiple sensing electrodes 12 are disposed on a lower surface of the transparent cover lens 11, and arranged into a two-dimensional array. The touch control chip 13 is disposed on the lower surface of the transparent cover lens 11 outside the view area. The touch control chip 13 is connected to each of the multiple sensing electrodes 12 via a wire.

In this embodiment, the light shielding layer 14 may be made of ink in various colors, or a light shielding material capable of being effectively combined with the transparent cover lens 11.

In addition, a flexible printed circuit 15 may further be disposed below the light shielding layer 14, and adapted to connect the touch control chip 13 to an external host. Specifically, the flexible printed circuit 15 may be bonded onto the lower surface of the transparent cover lens 11 via an anisotropic conductive film (ACF).

In this embodiment, the wires disposed in the view area require to be made of a material with excellent transparency, such as a transparent material (such as ITO) and a material with a small influence on the transparency (such as a silver nanowire with a width of 5 μm), thus facilitating to improve light transmittance on the view area. The wires disposed outside the view area may be made of a material with a small resistance without considering the transparency.

The arrangements for the sensing electrodes 12 and the touch control chip 13 as well as the connection between the sensing electrodes 12 and the touch control chip 13 in this embodiment may be implemented in a way of the first embodiment, and thus the description thereof will not be given repeatedly.

### Third Embodiment

FIG. 4 is a lateral structure schematic diagram of a capacitive touch screen according to a third embodiment of the present disclosure. The third embodiment differs from the second embodiment in that a transparent film 16 is added onto an outer surface of the transparent cover lens 11 and the light shielding layer 14 is disposed on a lower surface of the transparent film 16. As shown in FIG. 4, multiple sensing electrodes 12 are disposed on the lower surface of the transparent cover lens 11, and arranged into a two-dimensional array. The touch control chip 13 is disposed on the lower surface of the transparent cover lens outside the view area; the touch control chip 13 is connected to each of the multiple sensing electrodes 12 via a wire. The transparent film 16 covers an upper surface of the transparent cover lens 11. The light shielding layer 14 is disposed between the transparent film 16 and the transparent cover lens 11, and the light shielding layer 14 is located outside the view area of the transparent cover lens 11.

In this embodiment, the transparent film 16 may be a polyethylene terephthalate (PET) film, a polycarbonate (PC) film, a polymethyl methacrylate (PMMA) film or the like. The light shielding layer 14 may be made of ink in various colors or a light shielding material capable of being effectively combined with the transparent film.

Compared with the second embodiment, the technical solution in this embodiment adds the transparent film 16 onto the upper surface of the transparent cover lens 11 and disposes the light shielding layer 14 on the lower surface of the transparent film 16. The process for disposing the light shielding layer on the transparent cover lens 11 made of a glass material is complicated and the manufacture cost is high. However, the transparent film such as the PET film is relatively cheap and the process for disposing the light shielding layer on the transparent film is simple. Therefore, the manufacture cost can be effectively reduced.

In addition, a flexible printed circuit 15 may further be disposed below the light shielding layer 14, and adapted to connect the touch control chip 13 to an external host. Specifically, the flexible printed circuit 15 may be bonded to the lower surface of the transparent cover lens 11 via an ACF.

In this embodiment, the wires disposed in the view area require to be made of a material with excellent transparency, such as a transparent material (such as ITO) and a material with a small influence on the transparency (such as a silver nanowire with a wire width of 5 μm), thus facilitating to improve light transmittance on the view area. The wires disposed outside the view area may be made of a material with small resistance without considering the transparency.

The transparent film is adhered to the transparent cover lens via a whole piece of optical clear adhesive, or via a double sided adhesive.

The arrangements for the sensing electrodes 12 and the touch control chip 13 as well as the connection between the sensing electrodes 12 and the touch control chip 13 in this embodiment may be implemented in a way of the first embodiment, and thus the description thereof will not be given repeatedly.

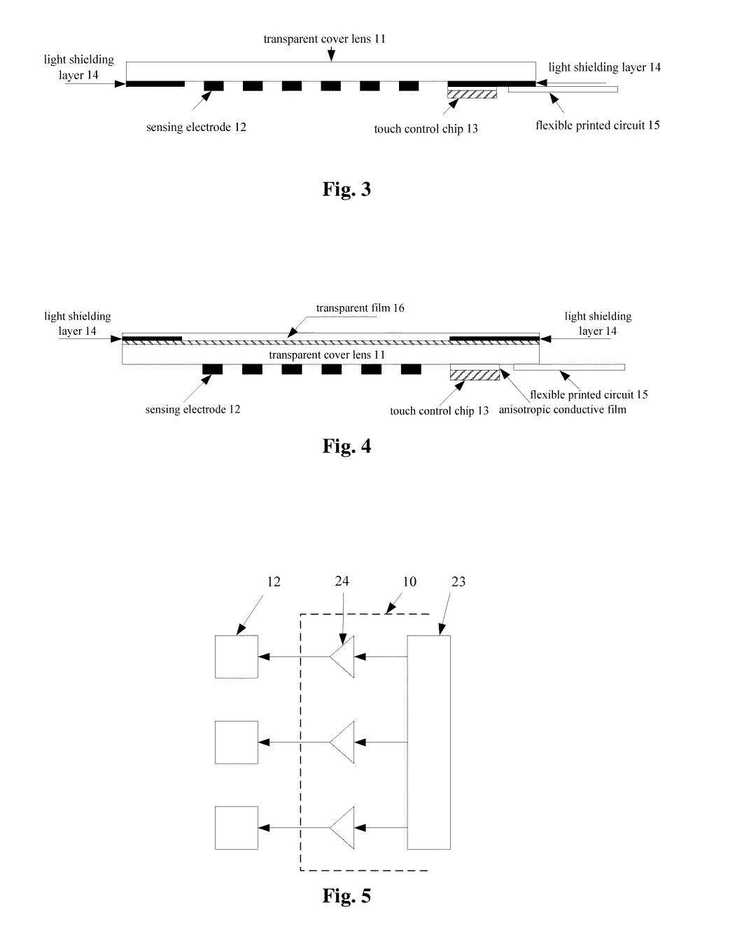

Based on the structures of the capacitive touch screen provided by the embodiments described above, FIG. 5 to FIG. 9 show methods for driving sensing electrodes according to the embodiment of the present disclosure. As shown in FIG. 5, the sensing electrode 12 is driven by a driving source 24, which may be a voltage source or a current source. It is not necessary to adopt the driving sources 24 with a same structure for respective sensing electrodes 12. For example, a part of the driving sources 24 may be voltage sources, and the other part of the driving sources 24 may be current sources. Furthermore, the driving sources 24 with a same frequency or different frequencies may be used for different sensing electrodes 12. A time sequence control circuit 23 controls the operation time sequences of each driving source 24.

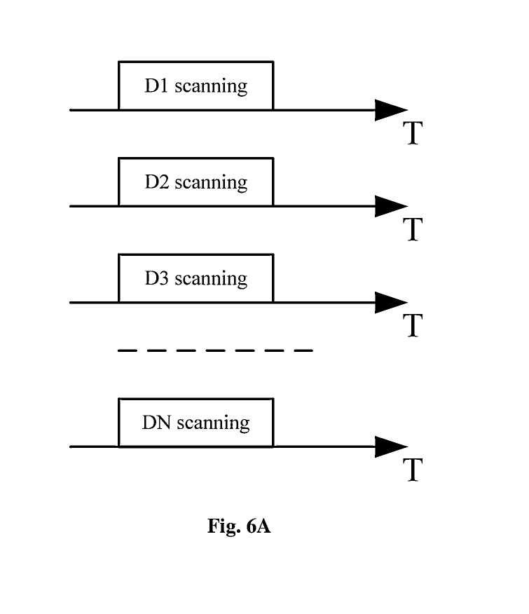

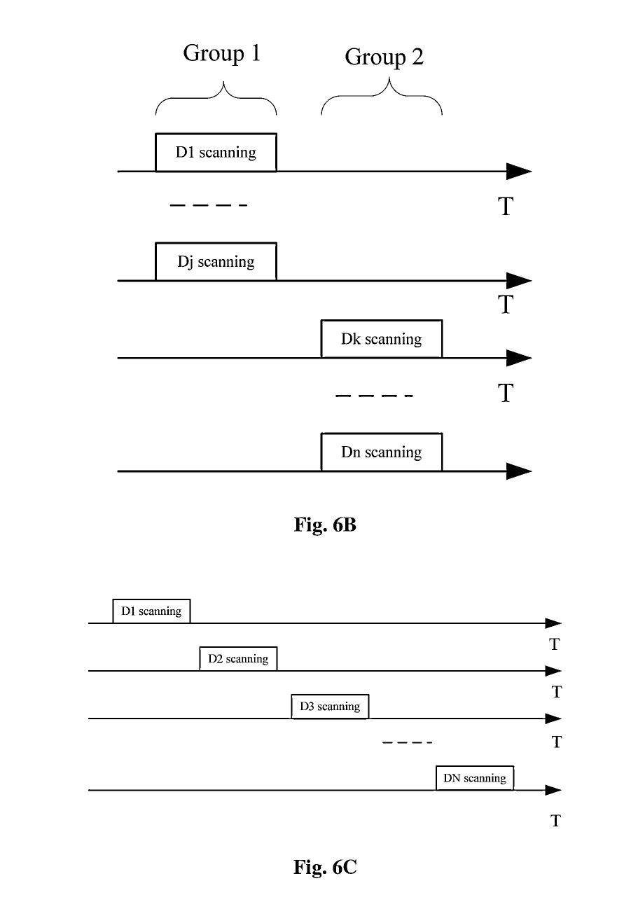

There are many options for driving time sequences of the sensing electrodes 12. As shown in FIG. 6A, all of the sensing electrodes are driven and detected simultaneously. In this way, the time for completing one scanning is the shortest, but the number of the driving sources (which is equal to the number of the sensing electrodes) is the most. As shown in FIG. 6B, the driving sources are grouped, and the electrodes in a specific region are driven by a group of the driving sources sequentially. In this way, the driving sources can be reused, but the scanning time is increased. A compromise may be met between the advantage of reusing the driving sources and the scanning time by selecting a proper number of the groups.

FIG. 6C shows a scanning way for conventional mutual-capacitance touch detection. Supposing that there are N drive channels (TX) and the scanning time of each TX is Ts, then the time for performing one frame scanning is N*Ts. However, all of the sensing electrodes may be detected simultaneously by using the method for driving the sensing electrodes in this embodiment. Therefore, the shortest time for performing one frame scanning is only Ts. That is, compared with the conventional mutual-capacitance touch detection, the scheme of this embodiment can enhance the scanning frequency by N times.

For a mutual-capacitance touch screen with 40 driving channels, if the scanning time for each driving channel is 500 μs, then the scanning time for the whole touch screen (one frame) is 20 ms, that is, the frame rate is 50 Hz. However, the frame rate of 50 Hz may not meet requirements of good experience usually. This problem can be solved by the scheme of the embodiments of the present disclosure. All of the sensing electrodes may be detected simultaneously in the case of the sensing electrodes arranged into a two-dimensional array. In a case where the detection time of each sensing electrode maintains 500 μs, the frame rate reaches 2000 Hz. This greatly exceeds the application requirement of most touch screens. Extra scanning data may be used by a digital signal processing unit, for example, anti-interference or optimizing touch traces, thus obtaining better results.

Preferably, the self-capacitance of each sensing electrode is detected. The self-capacitance of the sensing electrode may be a capacitance to ground thereof.

As an example, an electric charge detection method may be used. As shown in FIG. 7, a driving source 41 provides a constant voltage V1. The voltage V1 may be a positive voltage, a negative voltage or equivalent to the ground. S1 and S2 represent two controlled switches, 42 represents the capacitance to ground of the sensing electrode, and 45 represents a electric charge receiving module which may clamp the input voltage to a specified value V2 and measure an input or output quantity of electric charge. First, S1 is on and S2 is off, the upper plate of Cx is charged to the voltage V1 provided by the driving source 41. Then, S1 is off and S2 is on, charge exchange occurs between the Cx and the electric charge receiving module 45. Provided that the amount of electric charges transferred is Q1, and the voltage on the upper plate of the Cx becomes V2, then Cx=Q1/(V2−V1) is obtained from C=Q/ΔV to achieve the capacitance detection.

As another example, the self-capacitance of the sensing electrode may also be obtained by using a current source or by a frequency on the sensing electrode.

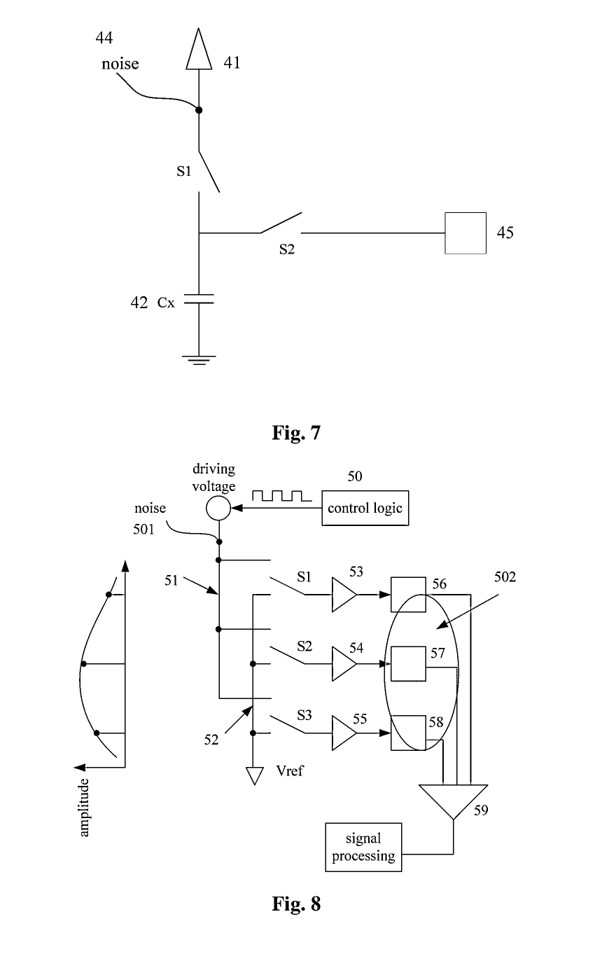

Optionally, in the case of multiple driving sources, when one sensing electrode is detected, sensing electrodes adjacent or peripheral to the detected sensing electrode may be driven by a voltage different from that of the driving source for driving the detected sensing electrode. For the purpose of conciseness, FIG. 8 shows only three sensing electrodes: one detected sensing electrode 57 and two sensing electrodes 56 and 58 adjacent to the detected sensing electrode 57. It should be understood by those skilled in the art that the example below is also applicable for a case that more sensing electrodes exist.

A driving source 54 connected with the detected sensing electrode 57 is connected to a voltage source 51 via a switch S2, so as to drive the detected sensing electrode 57. The sensing electrodes 56 and 58 adjacent to the detected sensing electrode 57 are connected with driving sources 53 and 55 respectively, and the sensing electrodes 56 and 58 may be connected to the voltage source 51 or a specific reference voltage 54 (such as ground) via switches S1 and S3. If the switches S1 and S3 are connected to the voltage source 51, that is, the detected sensing electrode and the sensing electrodes peripheral to the detected sensing electrode are driven simultaneously by the same voltage source. In this way, the voltage difference between the detected sensing electrode and the sensing electrodes peripheral to the detected sensing electrode may be reduced, which facilitates to reduce the capacitance of the detected sensing electrode and to prevent a false touch caused by a water drop.

Preferably, the touch control chip is adapted to adjust sensitivity or a dynamic range of the touch detection by parameters of the driving sources. The parameters include any of amplitude, frequency and time sequences or a combination thereof. For example, as shown in FIG. 8, the parameters (such as driving voltage, driving current and driving frequency) of the driving source and the time sequences of each driving source may be controlled by a control logic 50 of a signal driving circuit in the touch control chip. Different circuit working modes (such as a high sensitivity, a medium sensitivity or a low sensitivity) or different dynamic ranges may be adjusted by these parameters.

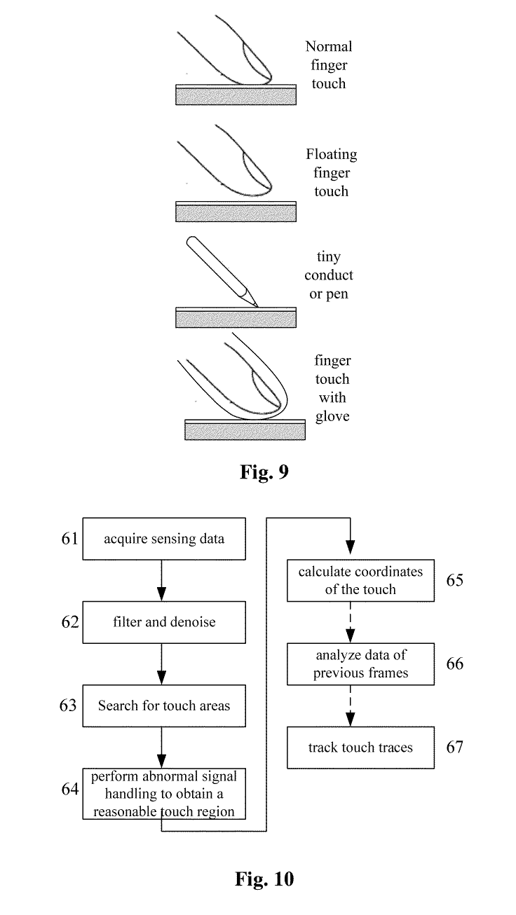

The different circuit working modes may be applicable for different application situations. FIG. 9 shows four application situations of the capacitive touch screen according to the embodiments of the present disclosure: a normal finger touch, a floating finger touch, an active/passive stylus or a tiny conductor touch, and a finger touch with glove. In conjunction with the parameters described above, the detection for one or more normal touches and one or more the tiny conductor touches may be achieved. It should be understood by those skilled in the art that although a signal receiving unit 59 is separated from the signal driving circuit 50 in FIG. 8, they may be integrated into one circuit in other embodiments.

FIG. 10 shows a signal-flow diagram of the touch control chip according to the embodiments of the present disclosure. When a touch takes place on a sensing electrode, the capacitance of the sensing electrode may be changed, and touch information may be restored by converting the change into a digital signal with an ADC. Generally, the change in capacitance is related to the area of the sensing electrode covered by a touch object. Sensing data of the sensing electrode is received by the signal receiving unit 59, and then is processed by a signal processing unit to restore the touch information.

As an example, a data processing method for the signal processing unit will be described in detail hereinafter. The data processing method includes Steps 61-65.

Step 61: acquiring sensing data.

Step 62: filtering and denoising to the sensing data. The purpose of this step is to eliminate background noises in an original image as far as possible and facilitate subsequent calculation. In particular, a spatial-domain filtering, a time-domain filtering or a threshold filtering may be used for this step.

Step 63: searching for possible touch areas. The areas include real touch areas and invalid signals. The invalid signals include a large-area touch signal, a power supply noise signal, an abnormal floating signal, a water-drop signal and so on. Among these invalid signals, some close to a real touch, some disturb the real touch, and some should not be parsed into a normal touch.

Step 64: performing abnormal signal handling to eliminate the invalid signals described above and obtain a reasonable touch area.

Step 65: performing a calculation from data of the reasonable touch area to obtain coordinates of a touch position.

Preferably, the coordinates of the touch position may be determined according to the two-dimensional sensing array. In particular, the coordinates of the touch position may be determined in centroid algorithm according to the two-dimensional sensing array.

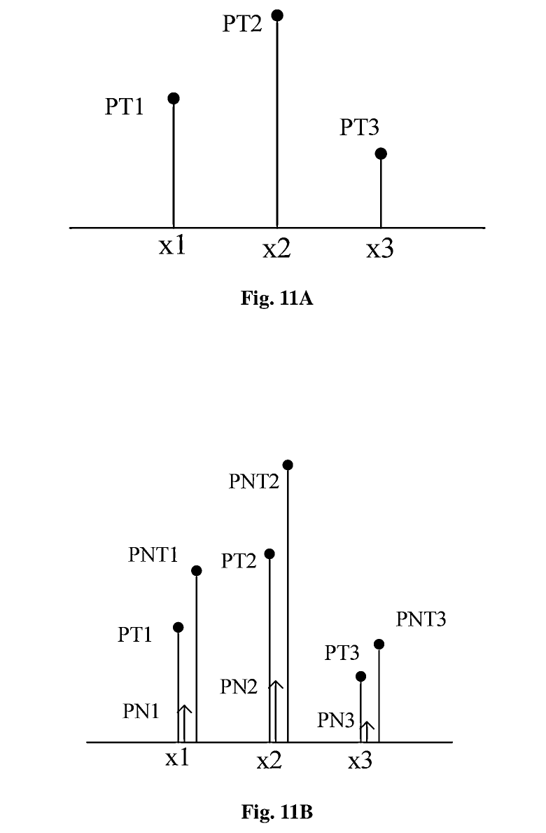

FIG. 11A shows an example for calculating coordinates of the touch position in centroid algorithm. For the purpose of conciseness, in the following description, only a coordinate of the touch position in one dimension is calculated. It should be understood by those skilled in the art that the entire coordinate of the touch position may be obtained by using a same or similar method. If the sensing electrodes 56 to 58 shown in FIG. 8 are covered by a finger, the sensing data corresponding to the sensing electrodes 56 to 58 is PT1, PT2 and PT3 respectively, and the coordinates corresponding to the sensing electrodes 56 to 58 are x1, x2 and x3 respectively. The coordinate of the finger touch position obtained in centroid algorithm is:

$${X}_{touch} = \frac{PT 1 * x 1 + PT 2 * x 2 + PT 3 * x 3}{PT 1 + PT 2 + PT 3} . \qquad ( 1 )$$

Optionally, step 66 may further be performed after the coordinates of the touch position are obtained. The step 66 includes: analyzing data of previous frames to obtain data of current frame by using data of multiple frames.

Optionally, step 67 may also be performed after the coordinates of the touch position are obtained. The step 67 includes: tracking touch traces according to the data of multiple frames. Furthermore, event information may also be obtained and reported according to user's operational process and then reported.

The capacitive touch screen according to the embodiment of the present disclosure can solve a problem of noise accumulation in the prior art on the premise of realizing multi-touch.

For example, a common-mode noise of a power supply is introduced at position 501 in FIG. 8. The influence of the noise on the calculation of the touch position will be analyzed hereinafter.

In a touch system based on mutual-capacitance touch detection in the prior art, there are multiple driving channels (TX) and multiple receiving channels (RX), and each RX is connected with all TXs. When a common-mode interference signal is introduced into the system, noise will be transmitted through all of the RXs due to the conductivity of the RXs. Specifically, in a case where there are multiple noise sources on one RX, noises from these noise sources will be accumulated, thus increasing the amplitudes of the noises. The voltage signal may swing on the detected capacitance due to the noise, thus resulting in false detection at a non-touch point.

In the capacitive touch screen provided by the embodiment of the present disclosure, there is no physical connection between the sensing electrodes out the touch control chip. Therefore, the noises can not be transferred and accumulated between the sensing electrodes, thus avoiding the false detection.

Taking a voltage detection method as an example, noises will cause a change of the voltage on a touched sensing electrode, thus resulting in a change in sensing data on the touched sensing electrode. According to the principle of the self-capacitance touch detection, a sensing value caused by the noise and a sensing value caused by the normal touch are all proportional to the area of the touched sensing electrode that is covered.

FIG. 11B shows an example for calculating coordinates of touch position in a centroid algorithm in a case that a noise exists. Provided that the sensing values caused by a normal touch are PT1, PT2 and PT3 respectively and the sensing values caused by the noise are PN1, PN2 and PN3, then (taking the sensing electrodes 56 to 58 as an example):

PT1 ∝ C58, PT2 ∝ C57, PT3 ∝ C56

PN1 ∝ C58, PN2 ∝ C57, PN3 ∝ C56

PN1=K*PT1, PN2=K*PT2, PN3=K*PT3, where K is a constant.

In a case where the voltage of the noise has a same polarity as that of the driving source, due to voltage superposition, the obtained sensing data is:

PNT1=PN1+PT1=(1+K)*PT1

PNT2=PN2+PT2=(1+K)*PT2

PNT3=PN3+PT3=(1+K)*PT3.

Accordingly, the coordinates obtained in centroid algorithm is:

$$\begin{matrix}{X}_{touch} = \frac{PT 1 * x 1 + PT 2 * x 2 + PT 3 * x 3}{PT 1 + PT 2 + PT 3} \\ = \frac{\begin{matrix}( 1 + K ) * PT 1 * x 1 + ( 1 + K ) * \\ PT 2 * x 2 + ( 1 + K ) * PT 3 * x 3\end{matrix}}{( PT 1 + PT 2 + PT 3 ) * ( 1 + K )} \\ = \frac{PT 1 * x 1 + PT 2 * x 2 + PT 3 * x 3}{( PT 1 + PT 2 + PT 3 )}\end{matrix} \qquad ( 2 )$$

Apparently equation (2) is equal to equation (1). Accordingly, the capacitive touch screen according to the embodiments of the present disclosure is immune to the common-mode noise. The coordinates finally determined will not be influenced by the noise as long as the noise does not exceed a dynamic range of the system.

In a case where the voltage of the noise has an opposite polarity to that of the driving source, a valid signal will be reduced. If the reduced valid signal can be detected, it will be clear from the above analysis that the coordinates finally determined are not influenced. If the reduced valid signal cannot be detected, data of the current frame is invalid. However, in the embodiment of the present disclosure, the capacitive touch screen may have a high scanning frequency which may be N (N is normally greater than 10) times larger than the conventional scanning frequency. Thus, the data of the current frame can be restored by using the data of multiple frames. It should be understood by those skilled in the art that the normal report rate will not be influenced by the process using the data of multiple frames since the scanning frequency is much larger than the report rate actually needed.

Similarly, in the case that the noise exceeds the dynamic range of the system in a limited amount, the current frame may also be corrected by using the data of multiple frames, so as to obtain correct coordinates. The inter-frame processing method is also applicable for interferences from radio frequency and from other noise sources such as a liquid crystal display module.

The above description of the embodiments of the present disclosure enables the present disclosure to be implemented or used by those skilled in the art. Various modifications to these embodiments will be apparent to those skilled in the art, and the general principle defined herein can be implemented in other embodiments without departing from the scope of the present disclosure. Therefore, the present disclosure will not be limited to the embodiments described herein, but in accordance with the widest scope consistent with the principle and novel features disclosed herein.

1. A capacitive touch screen, comprising:
a transparent cover lens;
a plurality of sensing electrodes disposed on a surface of the transparent cover lens, and arranged into a two-dimensional array; and
a touch control chip bonded onto the surface of the transparent cover lens, the touch control chip being connected with each of the plurality of sensing electrodes via a wire.

2. The capacitive touch screen according to claim 1, further comprising a flexible printed circuit connected with the touch control chip, the touch control chip and the flexible printed circuit being bonded onto the surface of the transparent cover lens via an anisotropic conductive film.

3. The capacitive touch screen according to claim 2, wherein the transparent cover lens is provided with a view area.

4. The capacitive touch screen according to claim 3, further comprising a light shielding layer disposed outside the view area of the transparent cover lens.

5. The capacitive touch screen according to claim 4, wherein the plurality of the sensing electrodes are disposed on a lower surface of the transparent cover lens, the touch control chip and the flexible printed circuit are disposed on the lower surface of the transparent cover lens outside the view area, and the light shielding layer is disposed on the lower surface of the transparent cover lens and located above the touch control chip and the flexible printed circuit.

6. The capacitive touch screen according to claim 4, further comprising a transparent film covering an upper surface of the transparent cover lens.

7. The capacitive touch screen according to claim 6, wherein the plurality of the sensing electrodes are disposed on the lower surface of the transparent cover lens, the touch control chip and the flexible printed circuit are disposed on the lower surface of the transparent cover lens outside the view area, and the light shielding layer is disposed on a lower surface of the transparent film.

8. The capacitive touch screen according to claim 6, wherein the transparent film is adhered to the transparent cover lens via a whole piece of optical clear adhesive, or the transparent film is adhered to the transparent cover lens via double sided adhesive.

9. The capacitive touch screen according to claim 6, wherein the light shielding layer is made of ink in various colors, or a light shielding material capable of being combined with the transparent cover lens or the transparent film.

10. The capacitive touch screen according to claim 6, wherein the transparent film is a polyethylene terephthalate film, a polycarbonate film or a polymethyl methacrylate film.

11. The capacitive touch screen according to claim 1, wherein the touch control chip is adapted to detect a self-capacitance of each of the sensing electrodes.

12. The capacitive touch screen according to claim 11, wherein the touch control chip is adapted to detect the self-capacitance of each of the sensing electrodes by:
driving the sensing electrodes with a voltage source or a current source; and
detecting a voltage, a frequency or an electrical quantity on each of the sensing electrodes.

13. The capacitive touch screen according to claim 11, wherein the touch control chip is adapted to detect the self-capacitance of each of the sensing electrodes by:
driving and detecting the sensing electrodes, and driving the rest of the sensing electrodes simultaneously, wherein a signal for driving the sensing electrodes and a signal for driving the rest of the sensing electrodes are a same voltage or current signal, or different voltage or current signal; or
driving and detecting the sensing electrodes, and driving sensing electrodes peripheral to the driven sensing electrode simultaneously, wherein a signal for driving the sensing electrodes and a signal for driving sensing electrodes peripheral to the driven sensing electrode are a same voltage or current signal, or different voltage or current signals.

14. The capacitive touch screen according to claim 11, wherein the touch control chip is adapted to detect the self-capacitance of each of the sensing electrodes by:
detecting all of the sensing electrodes simultaneously; or
detecting the sensing electrodes group by group.

15. The capacitive touch screen according to claim 11, wherein the touch control chip is adapted to determine a touch position according to a two-dimensional sensing array.

16. The capacitive touch screen according to claim 11, wherein the capacitive touch screen comprises a plurality of touch control chips bonded onto the transparent cover lens, wherein each touch control chip is adapted to detect a corresponding part of the plurality of sensing electrodes.
